(19) United States
(12) Patent Application Publication
(10) Pub. No.: US 2010/0127229 A1
(43) Pub. Date: May 27, 2010

(54) Drawworks

(76) Inventors: Hege Kverneland, Houston, TX (US); Åge Kyllingstad, Algard (NO); Magne Mathias Moe, Harstad (NO); Robert Lewis Bloom, Gainsville, TX (US)

Correspondence Address: National Oilwell Varco, c/o Williams, Morgan & Amerson, 10333 Richmond, Suite 1100, Houston, TX, 77042, US

(21) Appl. No.: 12/597,500

(22) PCT Filed: Apr. 24, 2008
(86) PCT No.: PCT/GB08/50291

§ 371 Date: Dec. 10, 2009

Related U.S. Application Data
(60) Provisional application No. 60/926,627, filed on Apr. 27, 2007.

(51) Int. Cl. B66D 1/22; F16H 57/10; F16H 57/08; B66D 1/14; B66D 1/24; B66D 5/12; B66D 5/02; B66D 5/14; B23P 6/00

(52) U.S. Cl. 254/356; 475/271; 475/331; 254/342; 188/151 R; 29/402.01

(57) ABSTRACT

A drawworks (10) comprising a permanent magnet motor (60) mounted inside a drum(40), said permanent magnet motor arranged to drive said drum via a gear system(50), characterised in that said gear system is located at least partially within said drum.

The present invention relates to a drawworks, a rig comprising such a drawworks, a method of upgrading a drilling rig, a gear system for use in the drawworks, a method of repairing a drawworks with such a gear system, a brake for using in the drawworks, and to a method of repairing a drawworks with such a brake.

A drawworks is used in connection the raising and lowering of a variety of loads. In wellbore operations, such as drilling a well for oil or gas, a drawworks is used on a rig or with a derrick to hold and to raise and lower tubulars, e.g., but not limited to, a drill string and associated equipment above, into and/or out of a wellbore. A travelling block with a hook or other similar assembly typically used for the raising and lowering operations is secured in block-and-tackle fashion to a crown block or other limit fixture located at the top of the rig or derrick. Operation of the travelling block is performed by means of a hoist cable or line, one end of which is secured to the rig floor or ground forming a “dead line”, with the other end secured to the drawworks proper and forming a “fast line”.

In certain aspects, prior drawworks include a rotatable cylindrical drum upon which cable or fast line is wound by means of a prime mover (motor) and power assembly. The drawworks and travelling block assembly are automatically controlled or operated by an operator, e.g. a “driller”. In association with the raising of the travelling block, the prime mover (motor) is controlled by the operator e.g. with a foot or hand throttle; or the drawworks is automatically controlled by a suitable control system. The drawworks is supplied with one or more suitable brakes—for routine operation and for emergencies. The lines or wirelines are usually wire ropes or steel cables, although other materials have also been used.

Drawworks motors are relatively heavy high-horsepower motors. They provide the power to raise and lower loads that can be many hundred ton loads, some exceeding a thousand tons. In a variety of common drawworks systems, a gear system is located outside the drawworks drum and housing, taking up space which can be at a premium, particularly on offshore rigs. In a variety of common drawworks, calliper disc brakes are used which are also located outside the drum or housing.

The use of permanent magnet (PM) motors has been suggested for drawworks. The main advantage is that the footprint of the drawworks is considerably reduced since the motor is housed wholly within the drum of the drawworks.

The present invention is based on the insight by the applicant that yet further reductions can be made on the size of the drawworks, and in particular by placing at least a part of the gear system and/or brake inside the drum. This insight has given rise to problems not previously encountered in the drawworks field.

One particular problem is that traditional drawworks offer a combination of two functions: line-pull and line speed. The former is useful for lifting very heavy loads (e.g. a BOP weighing perhaps as much as one thousand tons); the latter is useful for tripping operations where speed is essential (a typical maximum line speed is about 25 ms⁻¹). It is important to preserve this dual functionality if the new kind of drawworks motor is to be useful on drilling rigs.

The maximum torque of a PM motor can be increased by increasing its diameter. This means that the diameter of the drum has to be increased to house the motor. However, as the drum diameter increases the line pull is reduced thereby reducing the benefit of increased torque. On the other hand, PM motors have comparatively low RPM limiting line speed and thereby their usefulness for tripping operations.

A 2300 kW PM motor mounted in a 1.56 m internal diameter drum generates about 49,000 NM of torque. Transferring such large torques via a gear system, that is a least partially within the drum, to the line poses difficulties. At such torques smaller diameter gears require better manufacturing tolerances which are not economically feasible.

These particular problems are addressed by the use of a planetary gear system, and in certain aspects a planetary gear system having two gears. Furthermore better torque transfer is accomplished by mounting the planetary gears on flex pins whereby load is shared substantially equally between the planetary gears. This enables the diameter of the planetary gear system to be reduced without a corresponding increase in the required manufacturing tolerances.

According to the present invention there is provided a drawworks comprising a permanent magnet motor mounted inside a drum, said permanent magnet motor arranged to drive said drum via a gear system, characterised in that said gear system is located at least partially within said drum.

Further features of the drawworks are set out in claims 2 to 16 to which attention is hereby directed.

Placing at least a part of the brake within the drum has its own associated problems. For example, it is not practical to mount calliper brakes (traditionally used on drawworks brakes) inside the drum since maintenance becomes too difficult. Furthermore the diameter of the brake disc must be reduced to fit in the drum; the applicant has realised that braking a single smaller diameter disc would generate too much heat too be practical. Accordingly, to be mounted at least partly in the drum the brake should be relatively low maintenance and be able to dissipate the heat generated by braking.

These particular problems are addressed by a multi-disc brake comprising a first set of brake discs that rotate with the drum and a second set of brake discs that remain stationary. The two sets of brake discs may be brought into contact with one another to effect braking. This enables the kinetic energy of the drum to be dissipated as heat in a greater mass of material; at the same time the multi-discs are lower maintenance than standard calliper brakes.

According to the present invention there is provided a drawworks comprising a permanent magnet motor mounted inside a drum, said permanent magnet motor arranged to drive said drum, characterised by a brake system that is located at least partially within said drum.

Further features of the brake system are set out in claims to 21 to 30 to which attention is hereby directed. The brake system features of these claims may stand separately from the gear system features of claims 1 to 16. In other words the present invention envisages a drawworks comprising a brake system as aforesaid, with or without the gear system features of claims 1 to 16.

There is a need, recognized by the present inventors, for effective and efficient drawworks systems and brakes, gear systems, and motors for them. There is a need, recognized by the present inventors, for drawworks systems whose footprint is significantly reduced as compared to certain prior drawworks systems. There is a need, recognized by the present inventors, for reduced weight of equipment both for easy transportation for land rig applications and increased variable deck load on offshore vessels and floaters.

The present invention, in certain embodiments, provides a drawworks system with a permanent magnet motor located within a drum. In one aspect the motor includes a stationary stator that is secured to a primary central shaft and a rotor that is secured to and rotates with the rotating drum. In certain aspects the primary shaft has cooling channels therethrough through which a heat exchange fluid is circulated which can be any suitable fluid, e.g., but not limited to water, freon, liquid nitrogen, or antifreeze.

The present invention discloses, in certain aspects, a drawworks with a gear system which is located at least partially within the drawworks drum and, in certain particular aspects, a gear system that is entirely enclosed, partially within a system housing and partially within a drum. The present invention discloses, in certain embodiments, systems including: a rig; a derrick on the rig; a drawworks (any according to the present invention); a motor for powering the drawworks, the motor having a motor shaft, power cables for providing electrical power to the motor, a portion of each of the plurality of power cables passing through the shaft; and a plurality of channels passing through the shaft, the channels for the passage therethrough of a heat exchange fluid for the exchange of heat to cool the motor.

The present invention discloses, in certain aspects, drawworks having an “inside-out” permanent magnet motor.

The present invention discloses, in certain aspects, drawworks having a brake system located within a system housing. Such a brake system, in certain aspects, has a plurality of interleaved brake discs. Alternatively, systems according to the present invention have a brake system exterior to a system housing.

The present invention discloses, in certain aspects, drawworks having a gear system with planetary gears secured to gear carriers with flexpins that provide even load distribution on the planetary gears.

The present invention discloses, in certain aspects, drawworks having a gear system coupled to a motor with a splined connection for transferring high torque between the two parts and for easier assembly of the two parts.

The present invention discloses, in certain aspects, drawworks having a gear system in which gear shifting is effected by selectively moving a shifting sleeve in a two-step system to more efficiently use the power of the motor.

The present invention discloses, in certain aspects, drawworks having a brake system with a stationary brake hub that is connected to the systems primary shaft with a splined connection. Using the splined connection facilitates assembly and efficiently transfers high torque.

The present invention discloses, in certain aspects, drawworks with a torque arrestor connected to the systems primary shaft with a splined connection which efficiently transfers torque on a shaft to the exterior of the system.

The present invention discloses, in certain aspects, methods for moving an item in a rig system, the rig system for use in wellbore operations, the rig system as any described herein with a drawworks according to the present invention; the method including: raising or lowering the item by running the drawworks.

For a better understanding of the present invention reference will now be made, by way of example only, to the accompanying drawings in which:

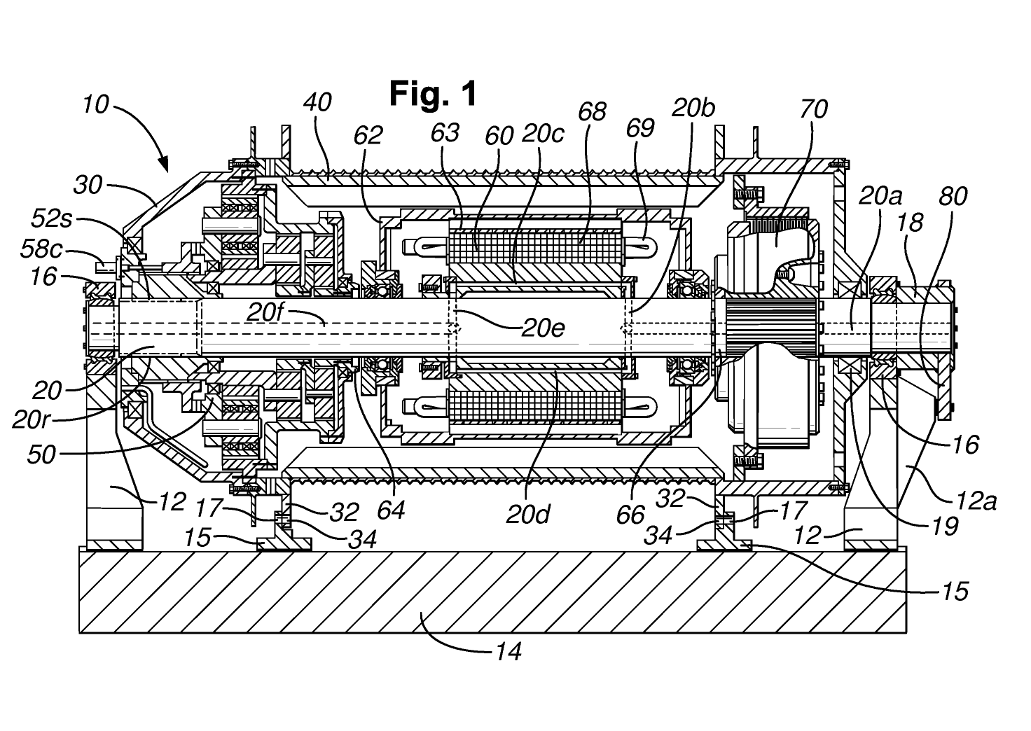

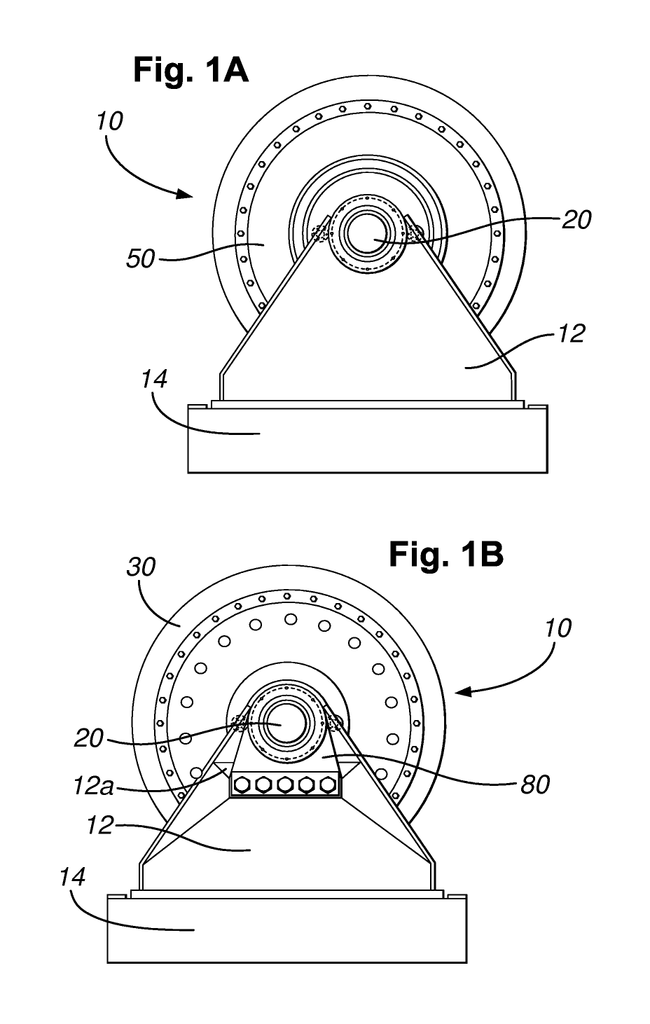

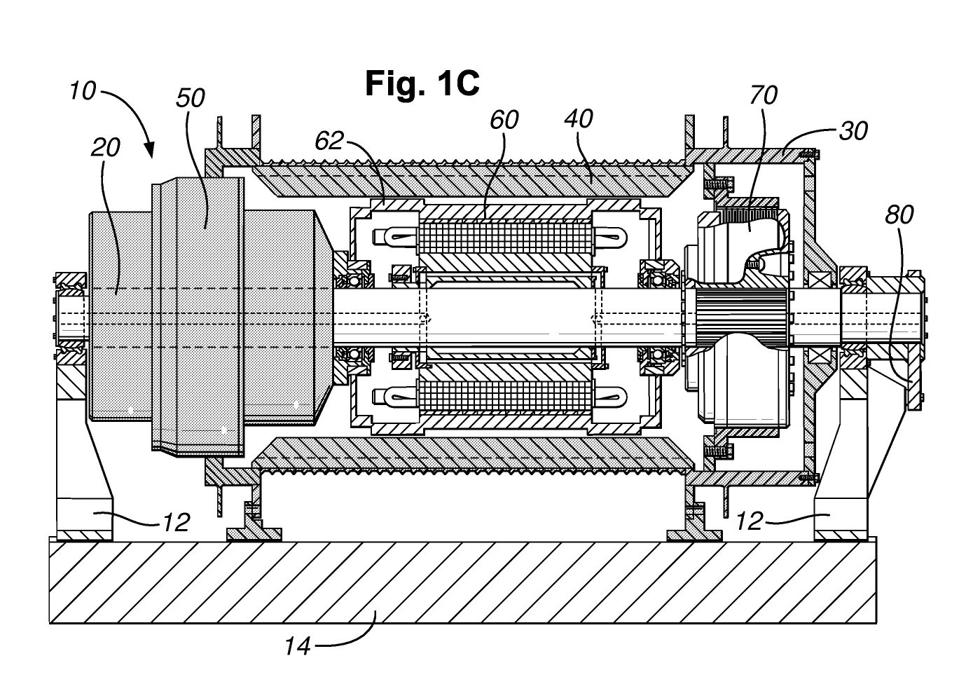

FIG. 1 is a side cross-section view of a drawworks according to the present invention;

FIG. 1A is an end view of the drawworks of FIG. 1 (left end as viewed in FIG. 1);

FIG. 1B is an end view of the drawworks of FIG. 1 (right end as viewed in FIG. 1);

FIG. 1C is a cross-section view of the drawworks of FIG. 1 with parts that rotate shaded;

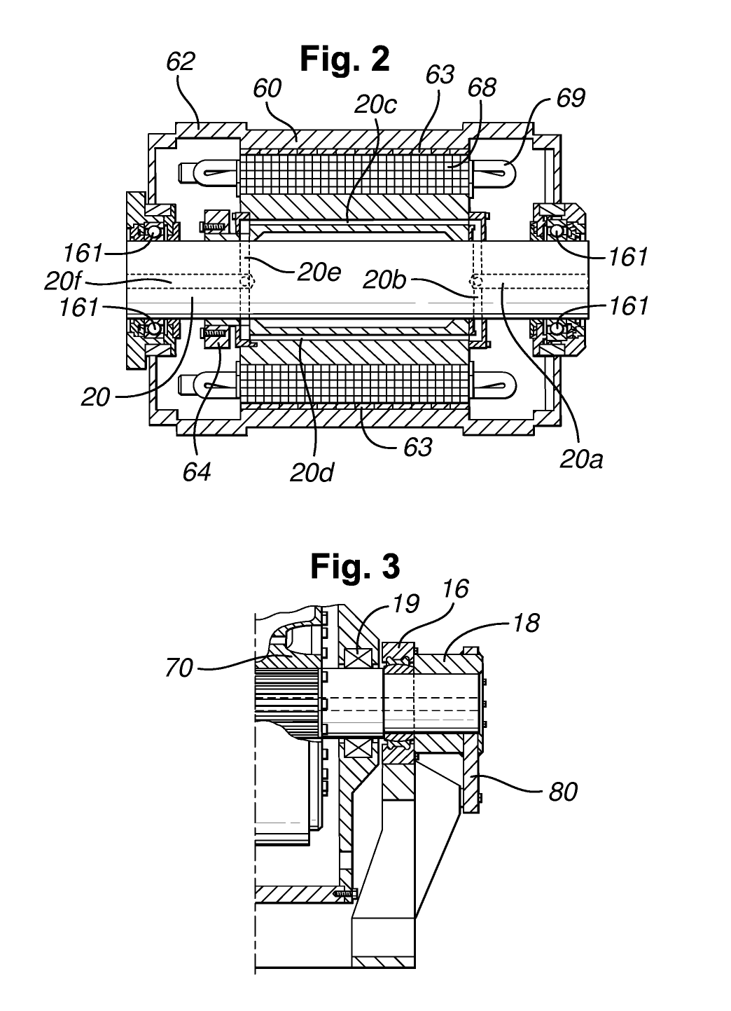

FIG. 2 is a cross-section view of a motor part of the drawworks of FIG. 1;

FIG. 3 is a cross-section view of a torque arrestor of the drawworks of FIG. 1;

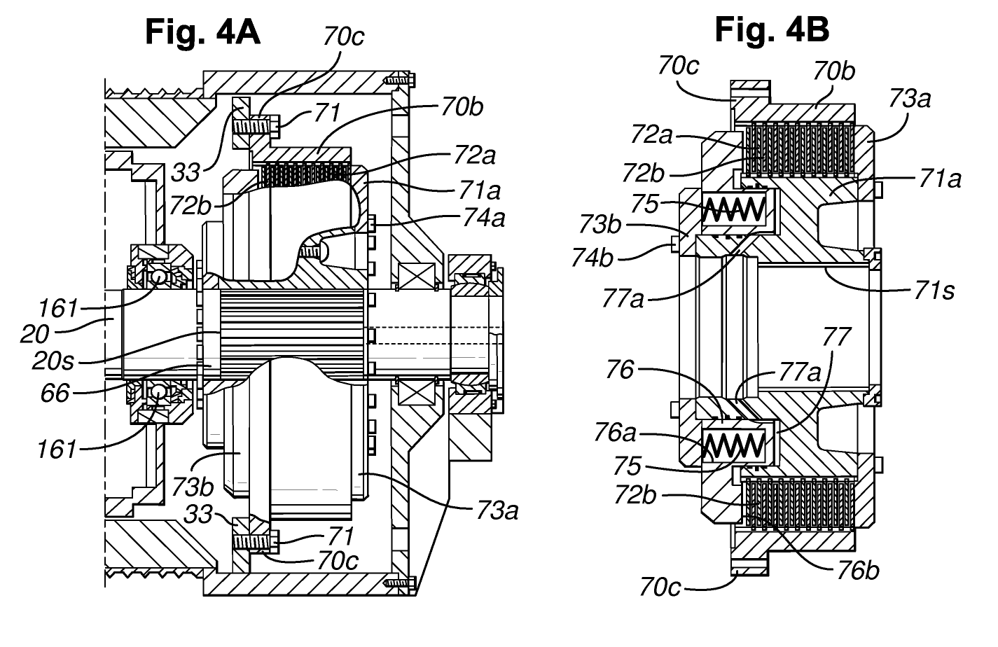

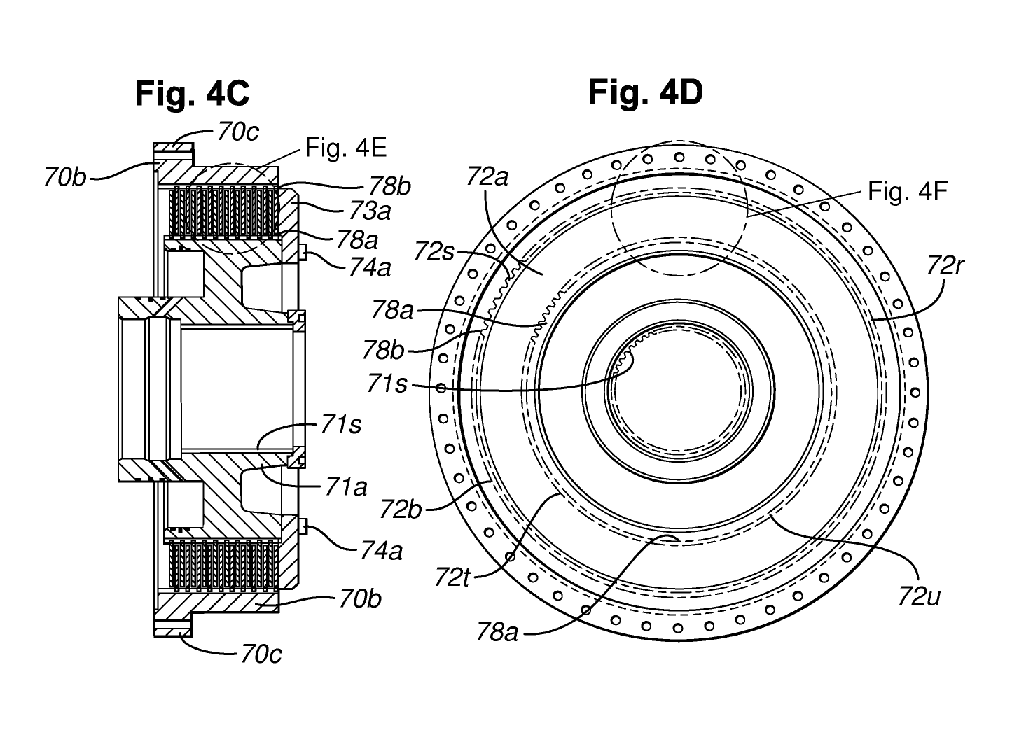

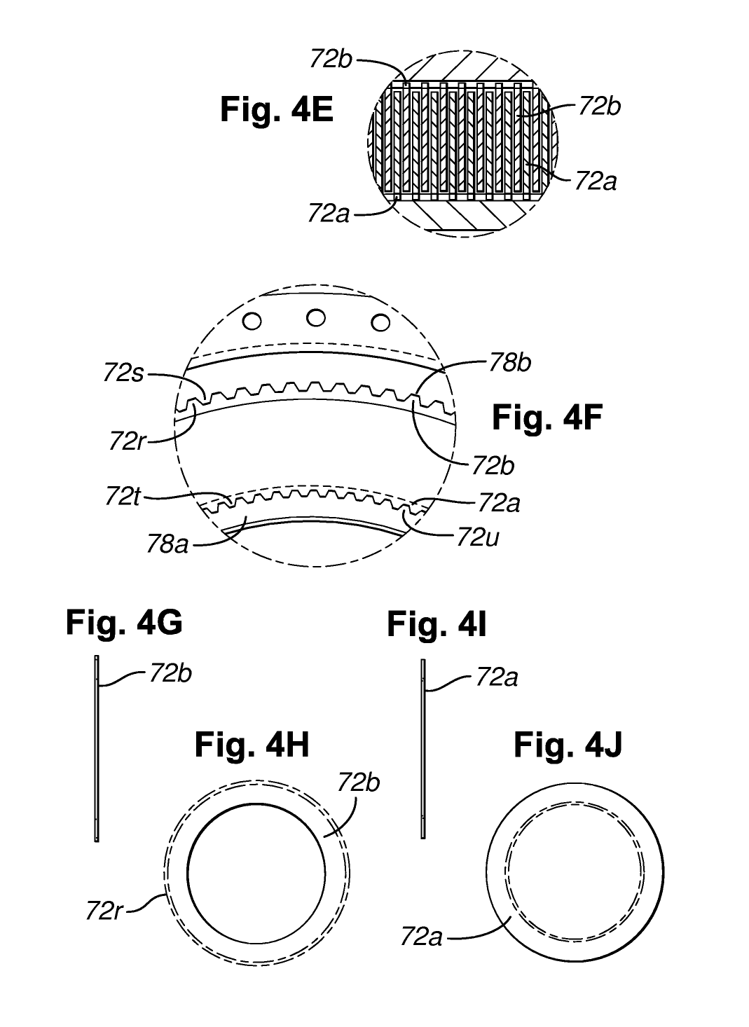

FIG. 4A is a cross-section view of a brake part of the drawworks of FIG. 1;

FIG. 4B is a cross-section view of part of the brake as shown in FIG. 4A;

FIG. 4C is a cross-section view of part of the brake as shown in FIG. 4A;

FIG. 4D is an end view of part of the brake as shown in FIG. 4A;

FIG. 4E is an enlargement of part of the brake shown in FIG. 4C;

FIG. 4F is an enlargement of part of the brake shown in FIG. 4D;

FIG. 4G is a side view of a brake disc of the brake shown in FIG. 4A;

FIG. 4H is a front view of a brake disc of FIG. 4G;

FIG. 4I is a side view of a brake disc of the brake shown in FIG. 4A;

FIG. 4J is a front view of a brake disc of FIG. 4I;

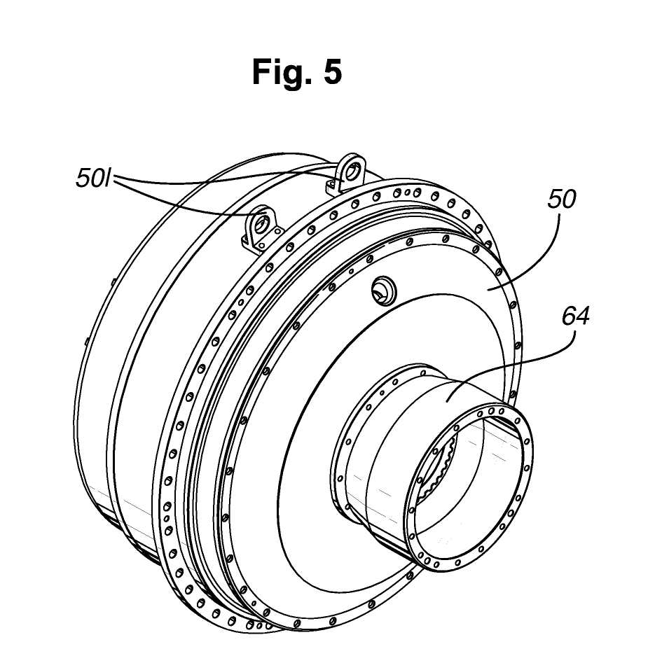

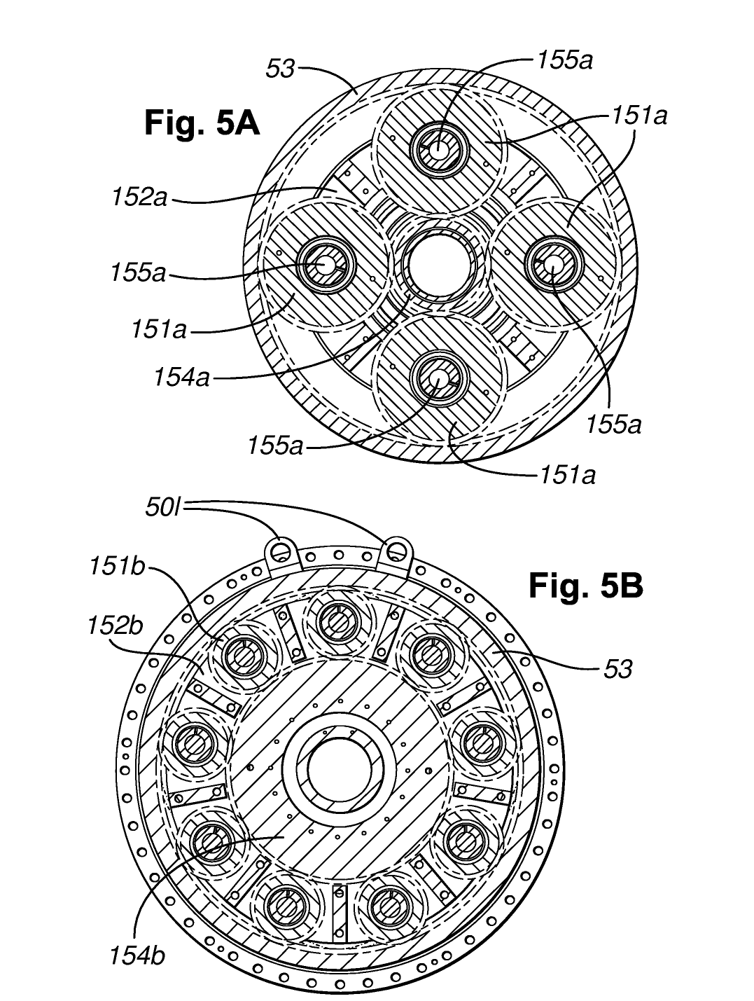

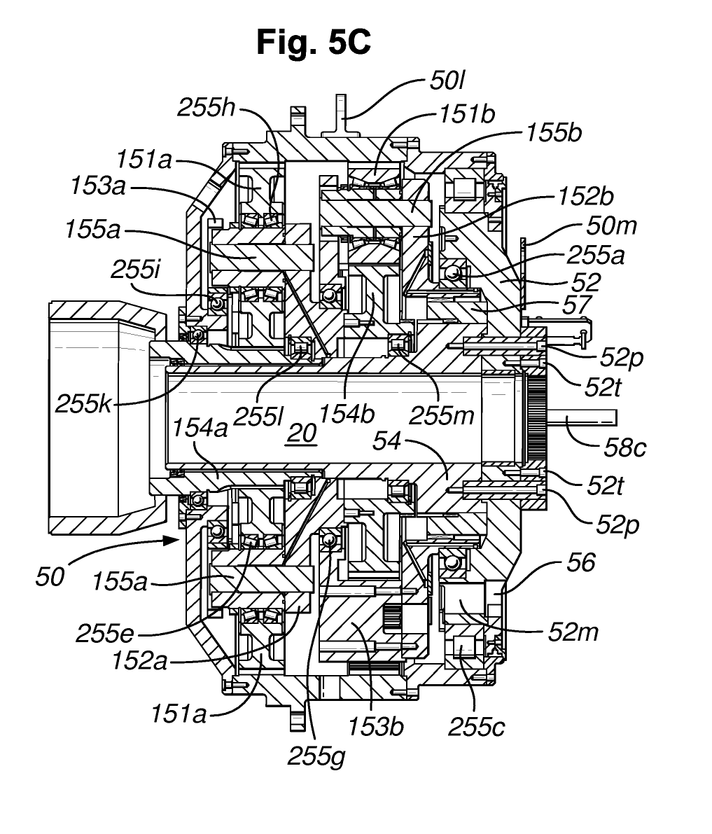

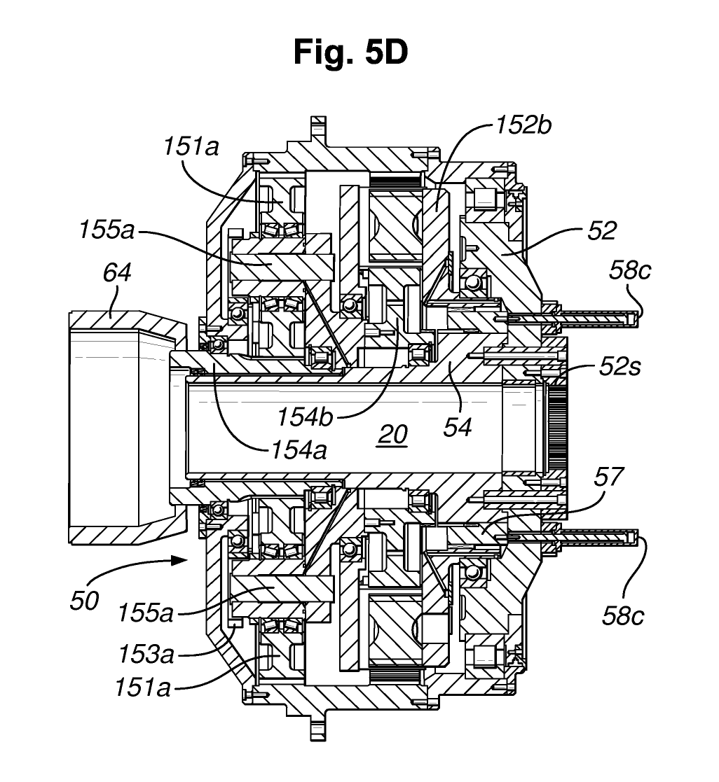

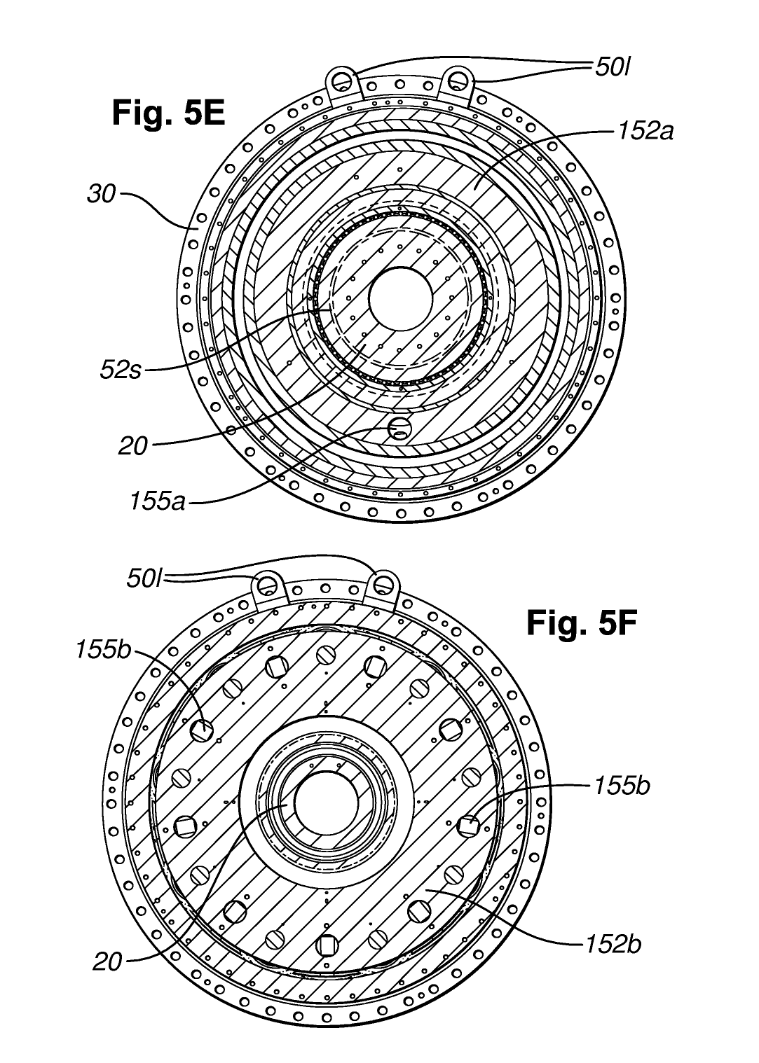

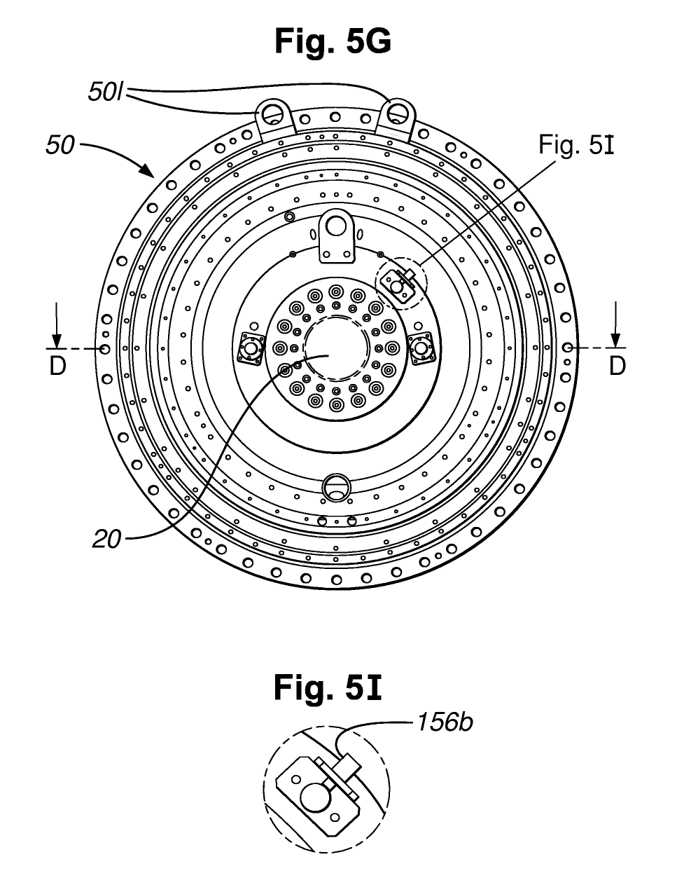

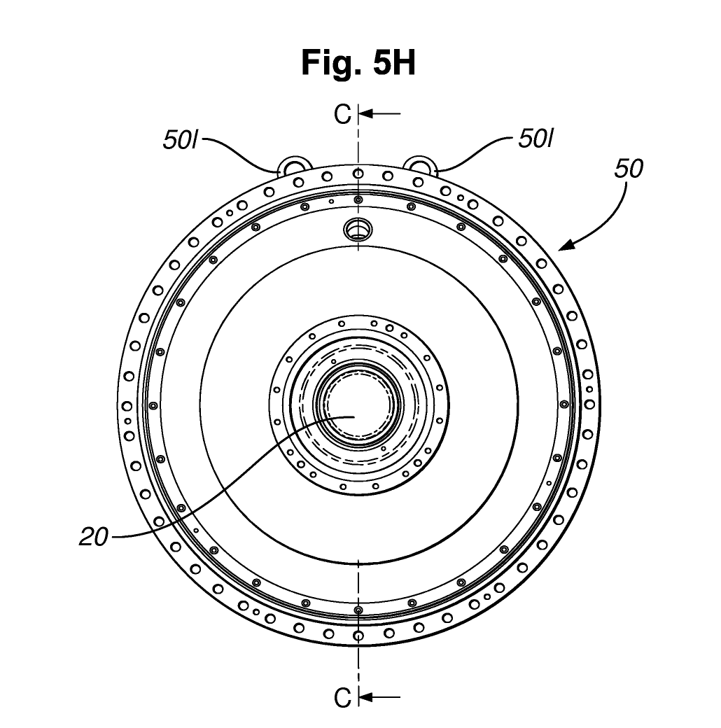

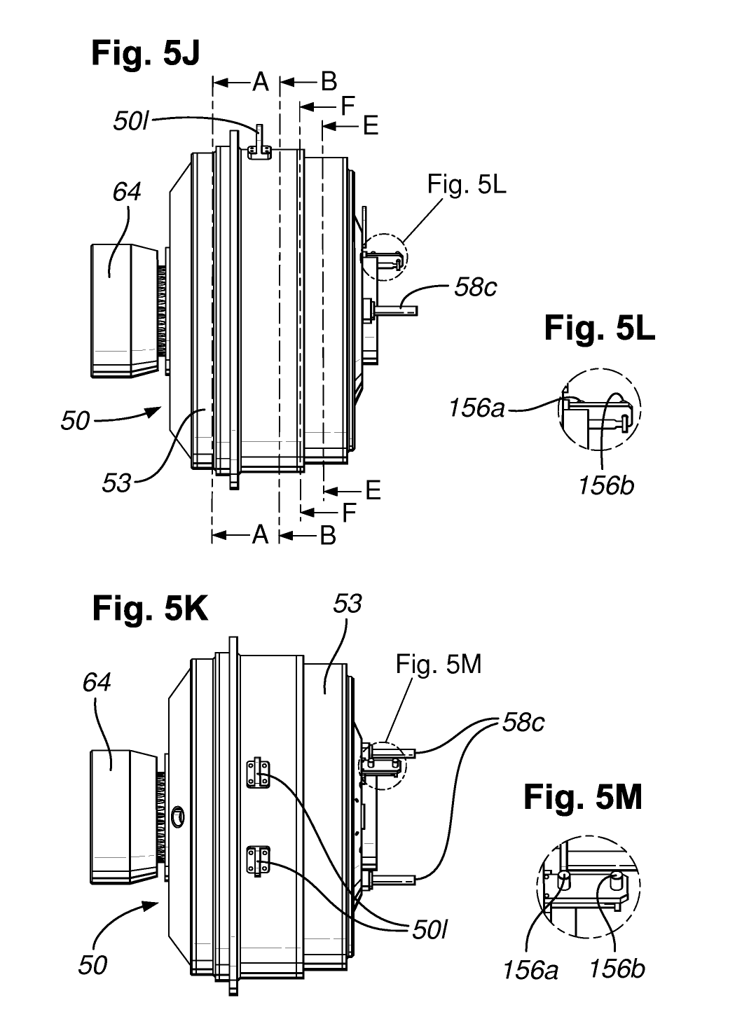

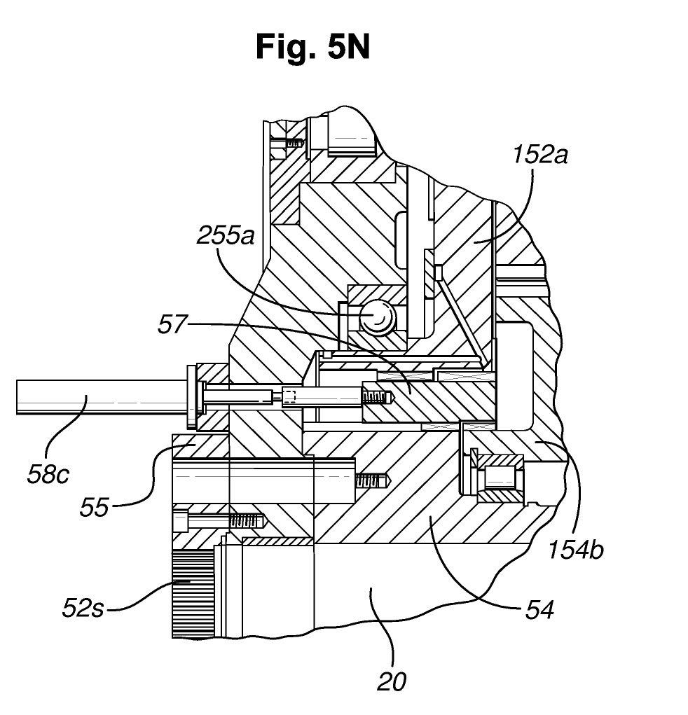

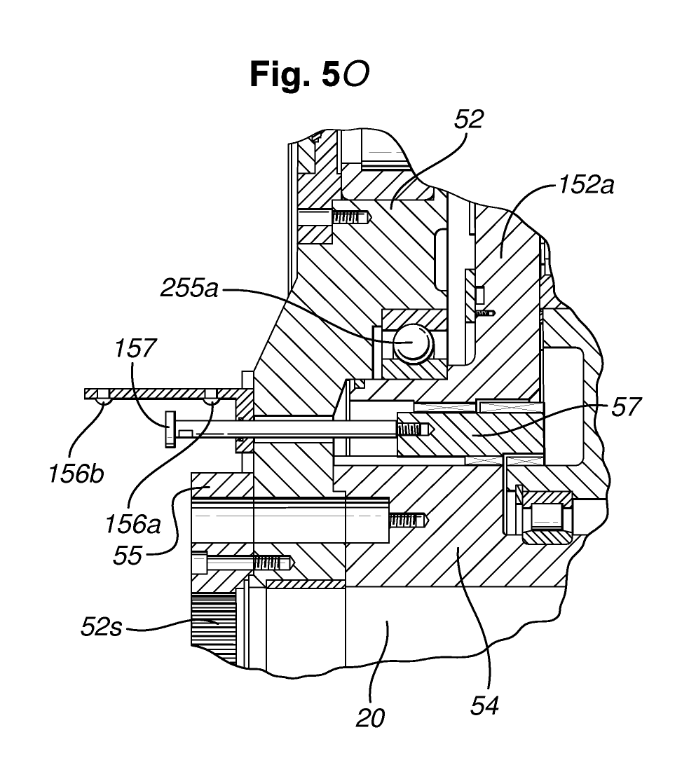

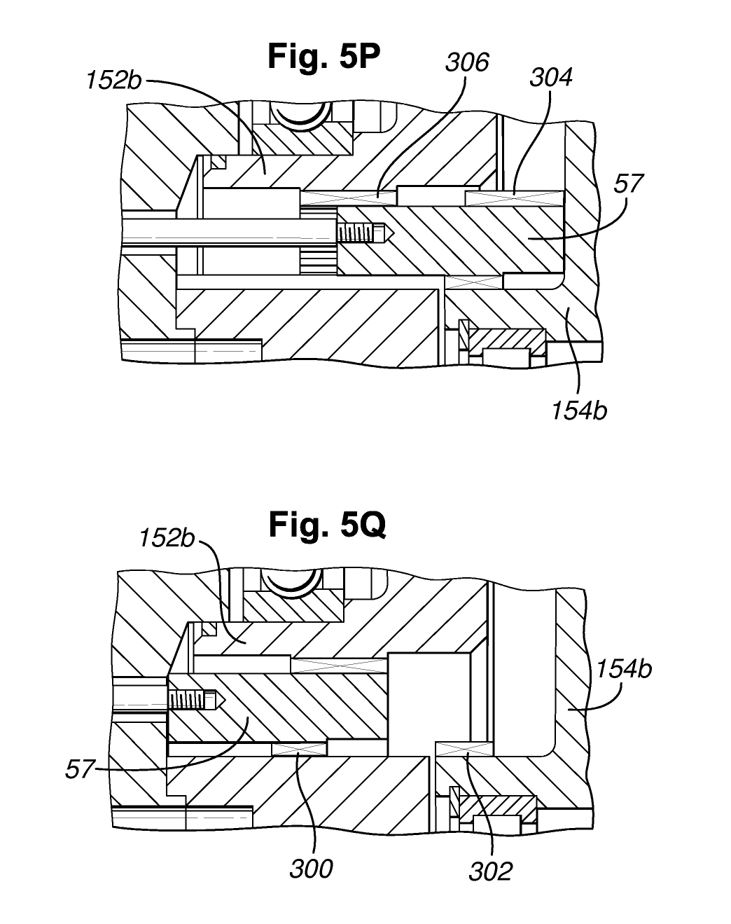

FIG. 5 is an isometric view of a gear system of the drawworks of FIG. 1;

FIG. 5A is a cross-section view of the gear system along line A-A of FIG. 5J;

FIG. 5B is a cross-section view of the gear system along line B-B of FIG. 5J;

FIG. 5C is a cross-section view of the gear system along line C-C of FIG. 5H;

FIG. 5D is a cross-section view of the gear system along line D-D of FIG. 5G;

FIG. 5E is a cross-section view of the gear system along line E-E of FIG. 5J;

FIG. 5F is a cross-section view of the gear system along line F-F of FIG. 5J;

FIG. 5G is an end view of the gear system of FIG. 5;

FIG. 5H is an end view of the gear system opposite the end shown in FIG. 5G;

FIG. 5I is an enlargement of part of the gear system shown in FIG. 5G;

FIG. 5J is a side view of the gear system of FIG. 5;

FIG. 5K is a side view of the gear system opposite the side shown in FIG. 5J;

FIG. 5L is an enlargement of part of the system shown in FIG. 5J;

FIG. 5M is an enlargement of part of the system shown in FIG. 5K;

FIG. 5N is a cross-section view of a gear selection mechanism part of the gear system of FIG. 5;

FIG. 5O is a cross-section view of a gear selection mechanism part of the gear system of FIG. 5, with some parts omitted for clarity;

FIGS. 5P and 5Q show the gear selection mechanism in different positions;

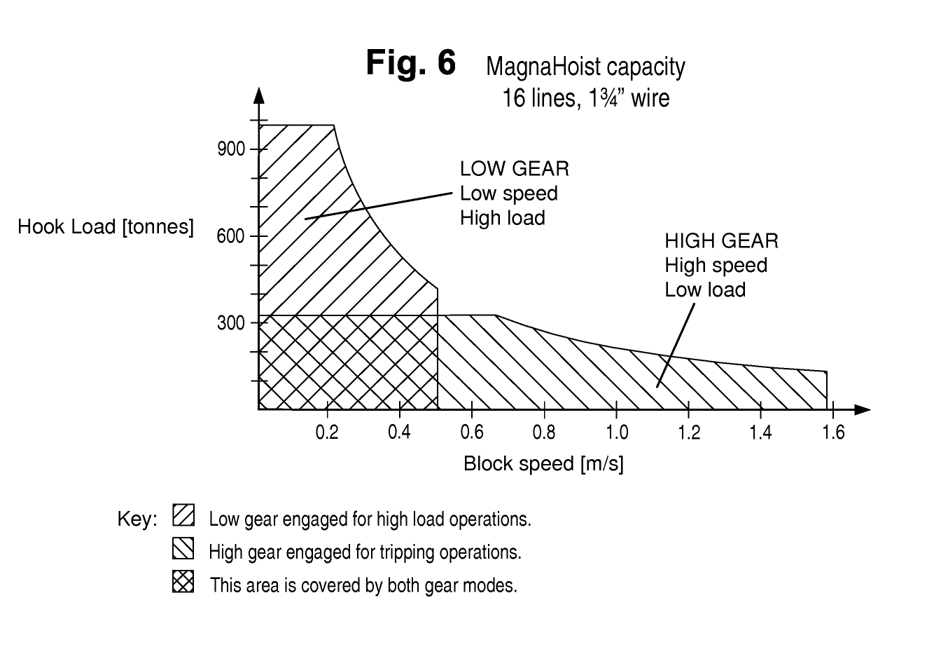

FIG. 6 is a graph of hook load versus block speed for a drawworks according to the present invention;

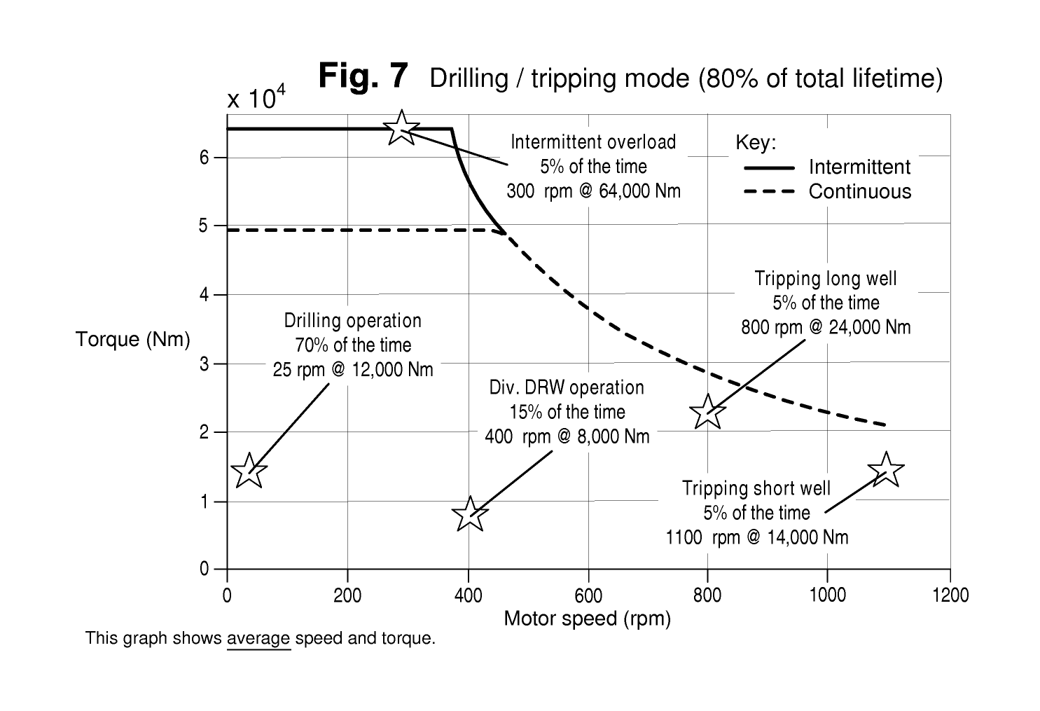

FIG. 7 is a graph of torque versus motor speed for a drawworks according to the present invention in high gear; and

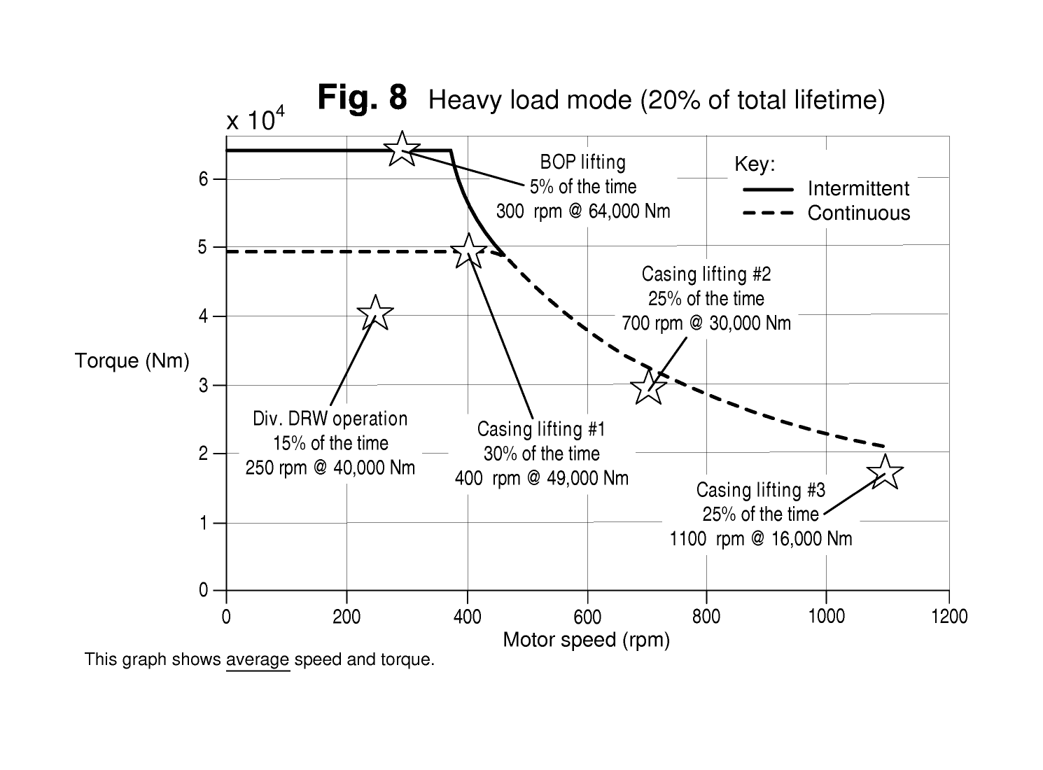

FIG. 8 is a graph of torque versus motor speed for a drawworks according to the present invention in low gear.

FIGS. 1-1C show a drawworks system 10 according to the present invention which includes a primary shaft 20 supported by supports 12 on a base 14; a motor 60 encompassing the primary shaft 20; a gear system 50 coupled to a rotor 62 of the motor 60; a housing 30 to which are connected the gear system 50 and the rotor 62 of the motor 60; a brake system 70 connected to the housing 30; and a drum 40 connected to the housing 30. Fluid conducting channels 20a, 20b, 20c, 20d, 20e, and 20f (see FIGS. 1 and 2) provide passageways for heat exchange fluid for cooling the motor 60. The channels 20c and 20d extend through the stator 68.

The drum 40 holds rope, line or cable to be reeled in by and payed out from the system 10.

The brake system 70 in this embodiment is within the housing 30. This housing, part of the planetary gear (described below), is connected to the drum 40 and rotates at the same speed as the drum. The motor 60 is within the drum 40 and comprises a permanent magnet motor having 24 poles and an output power of about 2300 kW. The gear system 50 is partially within the drum 40 and partially within the housing 30. Optionally, the brake system is located exterior to the housing.

A coupling 64 connects the gear system 50 to the rotor 62 of the motor 60. A coupling 66 connects the rotor 62 of the motor 60 to the brake system 70. The torque arrestor 80 is connected to the primary shaft 20 and is secured to a part 12a of a support 12. Bearing housings 16 on the supports 12 support the primary shaft 20. A bushing 18 encompasses the torque arrestor 80. A main bearing 19 of the drum 40 encompasses the shaft 20.

The housing 30 has lugs 32 with holes 34 therethrough. The base 14 has corresponding lugs 15 with holes 17 therethrough. Bolts (not shown) in the holes 34 and 17 hold the drum 40 and housing 30 immobile (e.g. during maintenance).

It is within the scope of the present invention for the motor 60 to be any suitable permanent magnet motor, including, but not limited to motors as disclosed in pending U.S. application Ser. No. 11/709,940 filed Feb. 22, 2007 and incorporated fully herein for all purposes. Further details of a suitable permanent magnet motor can be found in IADC/SPE: SPE-99078-PP ‘Utilizing Permanent Magnet Motor Technology on Larger Drilling Equipment for Improved Safety and Better Control’, Kverneland, H. et al. IADC/SPE Drilling Conference, Miami, 21-23 Feb. 2006; and in SPE-112312-PP ‘New Large Capacity Compact Drawworks for New Builds and Upgrade Jobs’, Kverneland, H. et al. IADC/SPE drilling Conference, Orlando, 4-6 Mar. 2008. Reference is specifically made to the features of the motors disclosed in these two papers. As shown in FIG. 1, the motor 60 has a stator 68 with windings 69 secured to the primary shaft 20. The rotor 62 has permanent magnets 63 secured thereto. The stator 68 is connected to the primary shaft 20 either with a flange connection or with a shrink-fitted connection.

The rotor 62 rotates on bearings 161 between the rotor 62 and the primary shaft 20.

The torque arrestor 80 transfers torque from the wire and drum via the shaft 20 to the base 14. In one aspect the connection between the torque arrestor 80 and the primary shaft 20 is a splined connection with splines of the torque arrestor 80 meshing with corresponding splines of the primary shaft 20. In certain aspects this insures that the primary shaft 20 and the torque arrestor 80 have the same torsional stiffness for proper load shearing in the spline.

FIGS. 4A-4J show the brake system 70 and details of its structure and parts. The brake system weighs about 3220 kg and has an outer diameter of 1400 mm and a length of about 580 mm. A stationary brake hub 71a is secured to the primary shaft 20 via a splined structure that includes splines 20s on the primary shaft 20 which engage with splines 71s on the stationary brake hub 71a. A rotating brake hub 70b has lugs 70c which are bolted with bolts 71 extending through the lugs 70c to housing lugs 33 and, thus, the rotating brake hub 70b rotates with the housing 30.

A plurality of discs 72a connected to the stationary brake hub 71a are interleaved with a corresponding plurality of discs 72b which are connected to the rotating brake hub 70b.

End plates 73a, 73b are at opposite ends of the brake system 70 and are bolted with bolts 74a, 74b, respectively, to the stationary brake hub 71a.

Springs 75 are disposed within channels 76a in a spring hub 76. The springs 75 urge the spring hub 76 so that an end 76b of the spring hub 76 pushes the brake discs together to effect braking action (springs urging the spring hub to the right as shown in FIG. 4B). Brake fluid under pressure within an inner chamber 77 of the spring hub 76 normally prevents the springs 75 from urging the spring hub 76 toward the brake discs. When braking action is desired, the brake fluid is evacuated from the chamber 77 via outlets 77a, thus permitting the springs 75 to move the spring hub 76 to compress the brake discs against one another. The brake fluid under pressure is supplied from a fluid pressure source (not shown) and braking is controlled by a control apparatus (not shown).

The discs 72b have outer splines 72r which mesh with and slide in corresponding splines 72s of a sliding spline 78b. The discs 72a have inner splines 72t which mesh with and slide between splines 72u of a sliding spline 78a. Under action of the springs 75, the discs 72a and the discs 72b slide in their respective splines until they are ‘bunched’ together. In this way braking action takes place on both sides of the rotating discs 72b. When the brake is released fluid pressure is re-applied to the spring hub 76, and each disc 72a, 72b is returned to its original position under a restoring force provided springs (not shown). In this original position the discs are spaced apart from one another so that the discs 72b may rotate freely between the discs 72a.

The use of the springs 75 to apply the brakes insures a fail-safe operation of the brakes. If there is a failure of brake fluid pressure, e.g. in the event of a pressure failure, the brakes will be applied and the drum will stop.

FIGS. 5-5Q show a gear system 50 and parts thereof according to the present invention and parts thereof. The overall length of the gear system 50 is about 1.36 m (including coupling 64) and the maximum diameter is 1.7 m. That part of the gear system (i.e. up to the flange adjacent the lifting lugs in FIG. 5) that fits inside the drum 40 has in outer diameter of 1.56 m. The weight of the gear system 50 is approximately 8500 kg. The coupling 64 provides a splined coupling between the gear system 50 and the motor 60. As shown in FIG. 1C, the gear system 50 rotates with the rotor 62 and the housing 30.

A rotating gear housing 53 rotates around the primary shaft 20 and houses the various gears described below. The rotating gear housing 53 also rotates around a stationary end cover 52 which is secured to the primary shaft 20 with a splined connection which includes splines 52s on the end cover 52 which mesh with corresponding splines 20r on the primary shaft 20. A hollow gear shaft 54 encircles the primary shaft 20 and is connected to the end cover 52 with hollow dowel pins 52p. A lube oil outlet 56 that extends through the end cover 52 is in fluid communication with the interior of the rotating gear housing 53 via a channel 52n. Lube oil for the gear system flows through the lube oil outlet 56.

A gear shift sleeve 57 encompasses the hollow gear shaft 54 and is movable toward and away from the end cover 52 to shift the gears. Two actuators 58c move the sleeve 57. The gear system 50 is provided with lifting lugs 50l and 50m. A breather is used (not shown) to vent the interior of the gear system to reduce condensation therein.

A gear coupling actuator 58 includes two cylinders 58c and the sleeve 57.

Within the rotating gear housing 53 are a first planet wheels 151a; a first planet wheel carrier 152a; a first planet wheel carrier support 153a; a second planet wheels 151b; a second planet wheel carrier 152b; a second planet wheel support 153b; a first sun wheel 154a; and a second sun wheel 154b. Flexpins 155a connect the first planet wheels 151a to the first planet wheel carrier 152a; and flexpins 155b connect the second planet wheels 151b to the second planet wheel carrier 152b. The flexpins provide a double cantilevered mount for each planet wheel whereby translation (i.e. movement without skewing) of the planet wheels relative to the respective planet carrier is permitted. The flexpin comprises a central shaft mounted to a planet carrier. Each planet wheel is mounted to the other end of the central shaft. Further details of each flexpin can be seen in U.S. Pat. No. 3,303,713 to which reference is specifically made in this respect.

Proximity switches 156a, 156b (see FIG. 5J, FIG. 5K) provide signals indicating what gear the gear system is in.

Bearings 255a-255m facilitate movement of the parts between which they are located.

The shifting sleeve 57 has three positions—two end positions, Low and High; and a neutral (free) position. When a sleeve is activated, it goes to one of the two end positions—Low gear or High gear. For maintenance purposes, the sleeves are manually put in the neutral position (a “fake” end position) so that the drum can be manually rotated. FIG. 5O shows the shifting sleeve 57 in the neutral position. The shifting sleeve 57 comprises two sets of teeth: a first set of teeth 300 is positioned on the inner surface of the shifting sleeve 57 and the teeth are oriented so that axial movement of the sleeve in one direction (to the right in FIG. 5O) brings the first set of teeth 300 into engagement with a corresponding set of teeth 302 on the second sun wheel 154b to prevent that sun wheel rotating (this position is shown in FIG. 5P). Since the second sun wheel 154b is fixed to the first planet wheel carrier 152a, the latter is also prevented from rotating. In this position the gear system is in high gear for moving low loads at high speed and the drum 40 is driven by the planet gears 151a.

A second set of teeth 304 is positioned on the outer surface of the shifting sleeve 57 and the teeth are oriented so that axial movement of the sleeve in the opposite direction (to the left in FIG. 5O) brings the second set of teeth 304 into engagement with a corresponding set of teeth 306 on the second planet wheel carrier 152b to prevent it rotating. In this position the gear system is in low gear for moving heavy loads at low speed and the drum 40 is driven by the planet gears 151b. In the neutral position neither the first of teeth 300 nor the second set of teeth 304 is in contact with the teeth 302 or 306 and thereby the drum 40 can be rotated manually for maintenance purposes.

It is within the scope of the present invention to employ gears with any suitable gear ratios. In one particular aspect the two-step planetary gear system as shown provides a 1:3.77 gear ratio for heavy loads and a 1:11.43 gear ratio for tripping pipe. In certain aspects the gear systems according to the present invention are lubricated and cooled with hydraulic oil or with gear oil. It is within the scope of the present invention to have two or more gears and two or more different gear ratios including but not limited to, gear ratios for a high speed mode and for a high torque mode. Also, a gear ratio can be provided for a medium speed mode. Furthermore it is within the scope of the present invention for the planetary gear system to have only one gear.

A position pin 157 is mechanically connected to the sleeve 57 and moves in and out when the sleeve 57 is pushed in and out by the two hydraulic cylinders 58c. The two cylinders 58c are connected hydraulically in parallel so that both move simultaneously. FIGS. 5N and 5O show the gear apparatus in a neutral position (gear not engaged). As explained above with the gear in high speed mode, the sleeve 57 is its very right position (see FIG. 5P), and the second sun wheel 154b is blocked. The two cylinders 58c are pressurized on the piston side, so the piston rods are fully extended. Only the first sun gear 154a is now engaged. The position pin 157 is in its very right position, and the proximity switch 156a gives a positive feedback to the drawwork control system, confirming the high gear, high speed position.

The drawwork drum 40 is (and must be) at standstill during gear shifting operations. The brake system 70 must be applied during gear shifting operations. The control system prevents the possibility of gear change if the fail safe brakes are not applied. When shifting gears from low load, high speed mode to high load, low speed mode, hydraulic pressure is applied to the rod side of the two pistons 58c, moving the sleeve 57 towards left.

When the two cylinders are in a left end position, i.e. both cylinder rods fully retracted, the sleeve 57 is in its very left position, and the planet wheel carrier 152a is locked. Both first sun gear 154a and second sun gear 154b are now engaged, and the gear is in high load mode. Position pin 157 is now in left position, and the proximity switch 156b gives a positive feedback to the control system, confirming the low gear, low speed position.

When a positive feedback is given from the proximity switch 156b, the brake can now be released and the drawworks operated. If there is no positive feedback from any of the two proximity switches 156a or 156b, the brakes will not be released, and the drawworks can not be operated. Only in Service Mode is it possible to operate the brakes without having a positive feedback from the one of the proximity switches.

A particular advantage of the present invention is the reduction in weight and footprint of the drawworks. An apparatus according to the invention is manufactured by the applicant under the trade mark MAGNAHOIST. Table 1 below shows a comparison between the dimensions, footprint and weight of a MAGNAHOIST compared to other equivalent power capacity drawworks currently available from National Oilwell Varco (NOV).

TABLE 1

| | Width | Length | Height | Footprint | Weight |
|---|---|---|---|---|---|
| | [mm] | [mm] | [mm] | [m²] | [kg] |
| MagnaHoist 1100 | 3840 | 5520 | 3100 | 20.1 | 38,000 |
| (incl. auxiliary equipment) | | | | | |
| National 1625-UDBE (1) | 5775 | 6760 | 2960 | 39.04 | 60,000 |
| Drawworks with sand reel and | | | | | |
| Baylor brake | | | | | |
| SSGD 500-3450 | 4250 | 7000 | 4200 | 29.75 | 64,000 |
| GA UDBE is an Oilwell | 5080 | 8290 | 3000 | 31.95 | 61,700 |
| E-3000 drawworks | | | | | |
| Dreco D3000 AC drawworks | 4635 | 6845 | 3520 | 31.7 | 50,000 |

As can be seen the weight reduction is between 24% and 41% and the reduction in footprint is between 32% and 48%.

The MAGNAHOIST is also smaller and lighter than some lower power drawworks, for example the 1320 UE also available from NOV. The overall length of the MAGNAHOIST is more than 2 metres shorter than the 1320 and it is also slightly smaller in width (3.64 m compared to 4.26 m. The height of the 1320 UE drawworks is approximately 2.9 m, whereas the MagnaHoist is 3.1 m. The total weight of the 1320 UE drawworks including motors, brakes etc is 52.5 tonnes, i.e. 14.5 tonnes heavier than the MAGNAHOIST.

The size and weight reduction of the MAGNAHOIST compared to a smaller capacity 1500 kW drawworks is a significant advantage, especially for upgrades on floater and jack-up type rigs where the old drawworks is replaced by a MAGNAHOIST or other drawworks in accordance with the invention. In particular, it is relatively easy to replace a smaller power capacity drawworks with the MAGNAHOIST since the footprint of the latter is smaller. However, the lifting capacity is substantially increased on the existing rig, and at the same time the equipment weight on the rig is reduced. This means that the variable deck load (VDL) capacity is increased, and the rating of the rig increases.

FIG. 6 shows a graph of block speed versus hook load for a drawworks according to the invention using 16 lines. It can be see how the two step gear system maintains both the tripping and line pull functionality of a drawworks that incorporates a PM motor. The dashed curve represents maximum hoist loads in low gear. This gear is not used very often; only during high load operations, for example when installing a BOP on the sea bed. Estimated operation time with this gear ratio is less than 20%. The dotted curve shows the actual hook load capacity in high gear. This gear with its pull capacity of 320 tonnes and maximum speed of 1.6 ms⁻¹, will cover the vast majority of the tripping and drilling operations.

FIG. 7 shows a graph of average torque versus motor speed for a drawworks according to the invention in high gear. This graph shows various points during drilling and tripping operations; these operations represent about 80% of the use of a drawworks. The continuous and intermittent torque versus speed characteristics of the drawworks are also shown. It can be seen that the drawworks meets the demands of tripping and drilling that are placed on it for 80% of its working life.

FIG. 8 shows a graph of average torque versus motor speed for a drawworks according to the invention in low gear. This graph shows various points during BOP and casing handling; these operations represent about 20% of the use of a drawworks. The continuous and intermittent torque versus speed characteristics of the drawworks are also shown. It can be seen that the drawworks meets the demands of BOP and casing handling that are placed on it for 20% of its working life.

One of the main advantages with the “inside-out” PM-motor in a drawworks 10 according to the invention is that the primary shaft 20 is stationary. Also, the PM-motor shaft is integral to the drawworks shaft, so the possibility for misalignment between motor and drum is reduced. Two spherical plain bearings are used in each end of the stationary motor shaft, reducing the requirement for alignment between the two bearings. This advantage is especially important during installation of the drawworks 10 on a rig: shimming and alignment of the drawworks frame becomes less critical. In a traditional drawworks the main shaft is rotating, requiring the drawworks frame including the bearing pedestals to be properly aligned. Misalignment often results in vibrations and noise in the equipment, which again leads to reduced lifetime on bearings and other main components, increasing the need for maintenance.

One advantage of the gear system 50 is that no specific maintenance is required as long as it is properly lubricated and cooled. The lubrication and cooling system consists of a hydraulic power unit including filters, heat exchanger and necessary instrumentation, everything mounted on the drawworks skid. When the drawworks 10 is in operation, lubrication oil is constantly sprayed on all main components in the gear box and circulated back to the hydraulic power unit. The main maintenance issue with the gear box is to make sure that the lubrication oil is properly cooled by the heat exchanger and that the oil is free of particles and water. The gear shifting mechanism and the hydraulic cylinders also needs to be checked periodically, in case of any external leakage in the cylinders. The gear box should provide over 20 years of operation.

One particular advantage of mounting the gear system and/or brake at least partially within the drum is that some extra protection is afforded to the gear system and/or brake by the drum. Being mounted in the drum can also help in meeting the necessary ATEX standards for operating in explosive atmospheres.

A drawworks according to the invention is particularly advantageous for use on smaller drilling rigs, such as floaters, vessels and semi-submersibles, where rig space is at a particular premium. The drawworks is also useful for upgrading fixed platforms and land rigs.

It is envisaged that a drawworks according to the invention may or may not comprise the brake system 70 as described in conjunction with the drawworks 10. For example a drawworks may be provided that comprises a gear system substantially as described herein mounted at least partially within the drum that uses a conventional calliper type brake system mounted outside the drum.

It is also envisaged that a drawworks according to the invention may or may not comprise the gear system 50 as described in conjunction with the drawworks 10. For example a drawworks may be provided that comprises a brake system substantially as described herein mounted at least partially within the drum that uses a conventional gear system mounted outside the drum.

It has been found that a drawworks with a motor of power 2300 kW, and a drum and gear system having dimensions as described herein, functions particularly well. However, it is within the scope of the invention for a drawworks using the principles of the invention to be downsized or upsized according to requirements.

1. A drawworks (10) comprising a permanent magnet motor (60) mounted inside a drum (40), said permanent magnet motor arranged to drive said drum via a gear system (50), characterised in that said gear system is located at least partially within said drum (40).

2. A drawworks as claimed in claim 1, wherein said gear system (50) comprises a planetary gear system at least a part of which has a diameter not greater than the internal diameter of said drum (40).

3. A drawworks as claimed in claim 1 or 2, wherein said gear system comprises two gears, a first gear selectable for providing a high gear for high speeds and low loads, and a second gear selectable for providing a low gear for low speeds and high loads, whereby said drawworks is useful for tripping operations requiring comparatively high line speed and lifting/lowering operations requiring comparatively high line pull.

4. A drawworks as claimed in claim 3, wherein said two gears are provided by a planetary gear system comprising said first gear and said second gear, said drawworks comprising a gear selection mechanism (57, 58c) for selecting said first and second gear.

5. A drawworks as claimed in claim 4, wherein in use said gear selection mechanism prevents rotation of one of a first planet carrier (152a) and a second planet carrier (152b), and leaves the other of said planet carrier free to rotate, whereby said drum (40) is driven by planetary gears (151a, 151b) of the fixed planet carrier.

6. A drawworks as claimed in claim 5, wherein a first sun gear (154a) is engaged with planetary gears (151a) of said first planet carrier (152a), the arrangement being such that, in use, said first sun gear (154a) is driven at the same speed as an output shaft of said permanent magnet motor (60).

7. A drawworks as claimed in claim 6, wherein said first planet carrier (152a) is connected to a second sun gear (154b), which second sun gear (154b) is engaged with planetary gears (151b) of said second planet carrier (152b) such that, when said low gear is selected, said first planet carrier (152a) is rotated by said first sun gear (154a) causing corresponding rotation of said second sun gear (154b) to drive said drum (40) via said planetary gears (151b) of said second planet carrier (152b).

8. A drawworks as claimed in claim 6, the arrangement being such that when said high gear is selected, said first planet carrier (152a) is locked via said second sun gear (154b), rotation of said first sun gear (154a) driving said drum (40) via said planetary gears (151a) of said first planet carrier (152a).

9. A drawworks as claimed in any of claims 5 to 8, wherein said gear selection mechanism comprises a member (57) moveable to lock directly or indirectly either said first planet carrier (152a) or said second planet carrier (152b).

10. A drawworks as claimed in claim 9, wherein said member (57) comprises a first set of teeth (300) and a second set of teeth (304), movement of said member to a first position bringing said first set of teeth (300) into engagement with corresponding teeth (302) for preventing rotation of said first planet carrier (152a), and movement to a second position bringing said second set of teeth (304) into engagement with corresponding teeth (306) for preventing rotation of said second planet carrier (152b).

11. A drawworks as claimed in claim 10, wherein said member (57) is moveable to a position away from both said first and second positions to provide a neutral position in which neither said first or second planet carrier is prevented from rotating.

12. A drawworks as claimed in claim 9, 10 or 11, wherein said member comprises a sleeve (57) substantially co-axial with a longitudinal axis of said gear system (50).

13. A drawworks as claimed in any of claims 9 to 12, wherein said gear selection mechanism further comprises an actuator (58c) for moving said member to switch between said first and second gears.

14. A drawworks as claimed in claim 2 or any claim dependent directly or indirectly thereon, wherein said gear system (50) comprises planetary gears (151a, 151b) mounted on a planet carrier (152a, 152b) so that, in use, the axis of rotation of each of said planetary gears is permitted to move relative to said planet carrier whereby increased torque may be taken into said gear system (50) for a given diameter of planetary gear system, and load is shared substantially equally between said planetary gears of said planet carrier.

15. A drawworks as claimed in claim 14, wherein said planetary gears (151a, 151b) are mounted to permit translation of each axis of rotation.

16. A drawworks as claimed in claim 14 or 15, wherein each of said planetary gears is mounted to said planet carrier using a double-cantilevered pin (155a, 155b) comprising a pin and a sleeve, one end of said pin mounted to said planet carrier and the other end of said pin mounting said sleeve, each of said planetary gears mounted on a respective sleeve.

17. A drawworks as claimed in any preceding claim, further comprising a brake (70) for braking said drum (40).

18. A drawworks as claimed in claim 17, wherein said brake (70) is located externally of said drum (40).

19. A drawworks as claimed in claim 18, wherein said brake (70) comprises a calliper braking mechanism.

20. A drawworks as claimed in claim 17, wherein said brake is located at least partially within said drum (40).

21. A drawworks as claimed in claim 20, wherein said brake comprises a first set of brake discs mounted on said stationary brake hub (71a) and a second set of brake discs (72b) mounted on said drum (40), said first set of brake discs interleaved with said second set of brake discs, whereby said first and second brake discs both fit inside said drum and, in use, are able to brake said drum.

22. A drawworks as claimed in claim 21, wherein first (72a) and second (72b) sets of brake discs are held apart from one another when said brake is not applied and when said brake is applied said first set of brake discs (72a) are urged against said second set of brake discs (72b) to effect braking of said drum (40).

23. A drawworks as claimed in claim 22, wherein upon release of said brake, said first set of brake discs (72a) are urged away from said second set of brake discs (72b) whereby said drum (40) may rotate without generation of heat by said brake.

24. A drawworks as claimed in claim 21, 22 or 23, wherein said first set of brake discs (72a) is mounted on and slidable along axially extending splines (78a) on said brake hub, whereby said first set of brake discs (72a) is inhibited from rotating about said brake hub but can be moved axially to apply and release said braking.

25. A drawworks as claimed in claim 21, 22, 23 or 24, wherein said second set of brake discs (72b) is mounted on and slidable along axially extending splines (78b) on said drum (40), whereby said second set of brake discs (72b) is rotated with said drum (40) and can be moved axially to apply and release said braking.

26. A drawworks as claimed in claim 24 and 25, wherein both said first (72a) and second (72b) sets of brake discs are slidable along their respective splines (78a, 78b), whereby axial movement of said first set of brake discs causes both sets of brake discs to be pressed against one another, whereby each stationary brake disc (72a) acts on two rotating brake discs (72b).

27. A drawworks as claimed in any of claims 20 to 26, wherein said brake further comprises a hub (76) moveable toward and away from said first (72a) and second (72b) sets of brake discs for applying and releasing said brake respectively.

28. A drawworks as claimed in claim 27, wherein said hub (76) is biased toward a first position and is held in a second position away from said first position by fluid pressure, whereby said hub may be moved between said first and second positions under control of said fluid pressure.

29. A drawworks as claimed in claim 28, wherein in said first position said hub (76) compresses said first (72a) and second (72b) sets of brake discs together, whereby in the absence of said fluid pressure said brake is applied to said drum (40).

30. A drawworks as claimed in any of claims 20 to 29, wherein said brake hub (71a) comprises axially extending splines engaged with corresponding splines (20s) on a stationary central shaft (20) passing through said drawworks.

31. A drawworks as claimed in any preceding claim, wherein said permanent magnet motor (60) comprises an inside-out permanent magnet motor.

32. A drawworks as claimed in any preceding claim wherein said permanent magnet motor (60) has an output power of between about 2000 kW and 2500 kW.

33. A drawworks as claimed in any preceding claim, wherein said permanent magnet motor (60) has an maximum output torque of about 49,000 Nm.

34. A drawworks as claimed in any preceding claim, wherein said drum (40) has an internal diameter of about 1.5 m.

35. A drawworks as claimed in any preceding claim wherein said drawworks (10) has a footprint of about 20 m².

36. A drawworks as claimed in any preceding claim, wherein said drawworks (10) has a weight of about 38,000 kg.

37. A drilling rig comprising a drawworks as claimed in any preceding claim.

38. A method of upgrading a drilling rig, which method comprises the step of removing a drawworks from said rig and installing a drawworks as claimed in any preceding claim.

39. A gear system for use in a drawworks as claimed in any of claims 1 to 36, which gear system comprises the gear system features of any of claims 2 to 16.

40. A method of repairing a drawworks as claimed in any of claims 1 to 36, which method comprises the steps of removing a gear system from said drawworks and fitting a gear system as claimed in claim 37.

41. A brake for use in a drawworks as claimed in any of claims 1 to 36, which brake comprises the brake features of any of claims 17 to 30.

42. A method of repairing a drawworks as claimed in any of claims 1 to 36, which method comprises the steps of removing a brake from said drawworks and fitting a brake as claimed in claim 41.
